(19) United States
(12) Patent Application Publication
(10) Pub. No.: US 2015/0312298 A1
(43) Pub. Date: Oct. 29, 2015

(54) METHOD AND SYSTEM FOR INFORMATION EXCHANGE AND PROCESSING

(71) Applicant: Kevin J. O'Keefe, Duxbury, MA (US)

(72) Inventor: Kevin J. O'Keefe, Duxbury, MA (US)

(21) Appl. No.: 14/006,133

(22) PCT Filed: Mar. 26, 2012
(86) PCT No.: PCT/US12/00166

§ 371 Date: Oct. 28, 2013

Related U.S. Application Data
(60) Provisional application No. 61/467,150, filed on Mar. 24, 2011.

(51) Int. Cl. H04L 29/06; G06F 17/30; H04L 29/08

(52) U.S. Cl. CPC H04L 65/60; H04L 67/10; G06F 17/30011

(57) ABSTRACT

An system and method for processing and transferring documents of any protocol between nodes in a distributed system, the system including an apparatus having a computer processor, and one of an encoding module and a decoding module corresponding to a schema of a document to be processed by the apparatus. Each of the encoding and decoding modules having a unique identifier corresponding to the schema and any process associated with the schema, the encoding module being configured to encode the document including embedding the unique identifier into the document for processing via the apparatus. The decoding module configured to decode an encoded document of the associated schema including restoring the document to its original form. The apparatus is scalable for transferring and processing documents of any protocol throughout a distributed system simultaneously over a single communication channel.

### CROSS-REFERENCE TO RELATED APPLICATIONS

This application claims the benefit of priority from U.S. Provisional Application No. 61/467,150 filed Mar. 24, 2011, the entire contents of which are incorporated herein by reference.

### BACKGROUND OF THE INVENTION

1. Field of the Invention

The present invention relates generally to systems and methods for data transfer between nodes in a network, and in particular, to a system and method for processing and transferring documents of any protocol over a single communication channel.

2. Description of the Related Art

Currently in many distributed systems, the services that enable the various components of a distributed system to communicate and manage data are middleware. Typical examples include Enterprise Application Integration (EAI) software, telecommunications software, transaction monitors, and messaging-and-queueing software.

Middleware enables interoperability between applications that run on different operating systems, by supplying services so the applications can exchange data in a standards-based way. Unfortunately, many available middleware products are static and usually restricted to a single protocol along with a single application interface for the exchange of data. A few application program interface (API) examples of currently used middleware include object brokers utilizing remote procedure calls, web services, SQL, and other specific software frameworks. Further, these type of middleware products are often limited to a single communications mechanism, e.g. a network connection.

Extending an implementation of most currently used middleware requires the services of a software engineer(s) for upgrading and/or rebuilding the middleware. For example, a typical effort to add a data element to data that flows between applications requires several steps including: enhancing the application interface framework with the new element and rebuilding the framework; and, each application that utilizes the framework would also have to be rebuilt to accommodate the new data element.

To modify most currently available middleware products to include capability for processing of a completely new protocol, would require a separate instance of the middleware built for the new protocol, as well as a separate communications channel that does not interfere with the transfer of data by the first instance of the middleware.

Accordingly what is needed is a system and method for processing information in a distributed system that provides processing and transfer of information in any protocol concurrently and via a single communication channel. Further, a need exists for dynamic modification of distributed systems to provide for processing and transfer of information of a new or different protocol without requiring shut down, software development and/or reconfiguration of the system.

### BRIEF SUMMARY OF THE INVENTION

The present invention provides an apparatus for processing and transferring documents of any protocol at or between nodes in a distributed system, the apparatus comprising a computer processor, and one of an encoding module and a decoding module corresponding to a schema of a document to be processed by the apparatus. Each of the encoding and decoding modules having a unique identifier corresponding to the schema and any process associated with the schema, the encoding module being configured to encode the document including embedding the unique identifier into the document for processing via the apparatus. The decoding module configured to decode an encoded document of the associated schema including restoring the document to its original form. The apparatus also includes a main process module for parallel processing of a plurality of transfer and/or processing modules for processing documents received by the apparatus. The apparatus is scalable for transferring and processing documents of any protocol throughout a distributed system simultaneously over a single communication channel.

In another embodiment, a method of transferring a document of any protocol between nodes of a distributed system is disclosed. The method including determining a schema of a document to be transferred from a source node to a destination node of a distributed system, and encoding the document at the source node using an encoding module corresponding to the schema of the document. The encoding including embedding a unique identifier assigned to the schema in the encoded document, the unique identifier corresponding to the schema of the document and any process associated therewith. The method including transferring the document to a destination node within the system, and decoding the document at the destination node using a decoding module corresponding to the schema of the document. The decoding including restoring the document to its original form for processing at the destination node.

The method further including generating each of an encoding and decoding module corresponding to the schema of each protocol of the documents to be transferred between nodes of the system. In one embodiment of the disclosed method, the step of transferring includes transferring documents of any protocol between nodes of the system simultaneously over a single communication channel using the IP protocol.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing an example of the arrangement of a data transfer apparatus according to an embodiment of the present invention;

FIG. 2 is a diagram showing an example of the arrangement of multiple data transfer apparatus coupled together via a network for data transfer therebetween or shown connected to a common memory or data storage device in accordance with an embodiment of the present invention;

FIG. 3 is a flowchart showing an example of an encode and decode library creation process and corresponding module according to one embodiment of the present invention;

FIG. 4 is a diagram showing an example of a library deployment application and process according to one embodiment of the present invention;

FIG. 5 is a diagram showing an example of a hub configuration application and process according to one embodiment of the present invention;

FIG. 6 is a flowchart showing an example of a hub initialization process according to one embodiment of the present invention;

FIG. 7a is a flowchart showing an example of a hub main process according to one embodiment of the present invention;

FIG. 7b is a flowchart showing an example of a hub termination process according to one embodiment of the present invention;

FIG. 8 is a flowchart showing an example of an external receipt processing application according to one embodiment of the present invention;

FIG. 9 is a flowchart showing an example of a local receipt processing application according to one embodiment of the present invention;

FIG. 10 is a flowchart showing an example of a disk monitoring process application according to one embodiment of the present invention;

FIG. 11 is a flowchart showing an example of a memory monitoring process application according to one embodiment of the present invention;

FIG. 12 is a flowchart showing an example of an ID processing application according to one embodiment of the present invention;

FIG. 13 is a flowchart showing an example of an external disbursement processing application according to one embodiment of the present invention;

FIG. 14 is a flowchart showing an example of an internal disbursement processing application according to one embodiment of the present invention;

FIG. 15 is a flowchart showing an example of a disk persistence processing application according to one embodiment of the present invention; and

FIG. 16 is a flowchart showing an example of a memory persistence processing application according to one embodiment of the present invention.

### DETAILED DESCRIPTION OF THE INVENTION

A preferred embodiment of the present invention is described below with reference to the several views of the accompanying drawings.

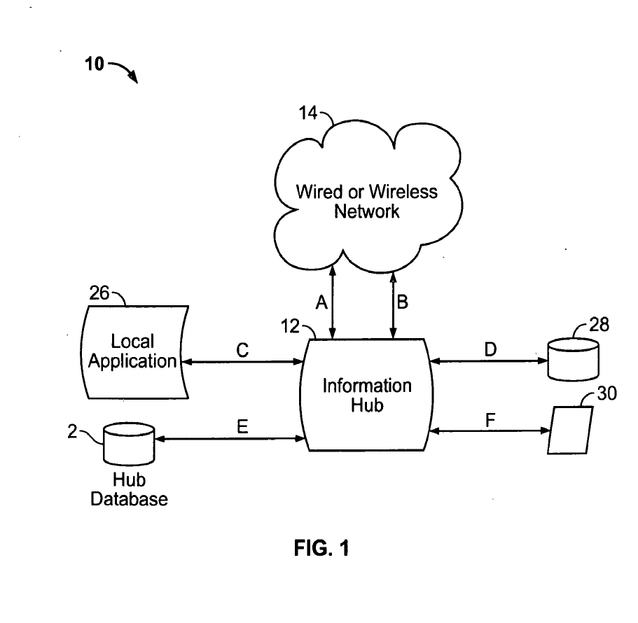

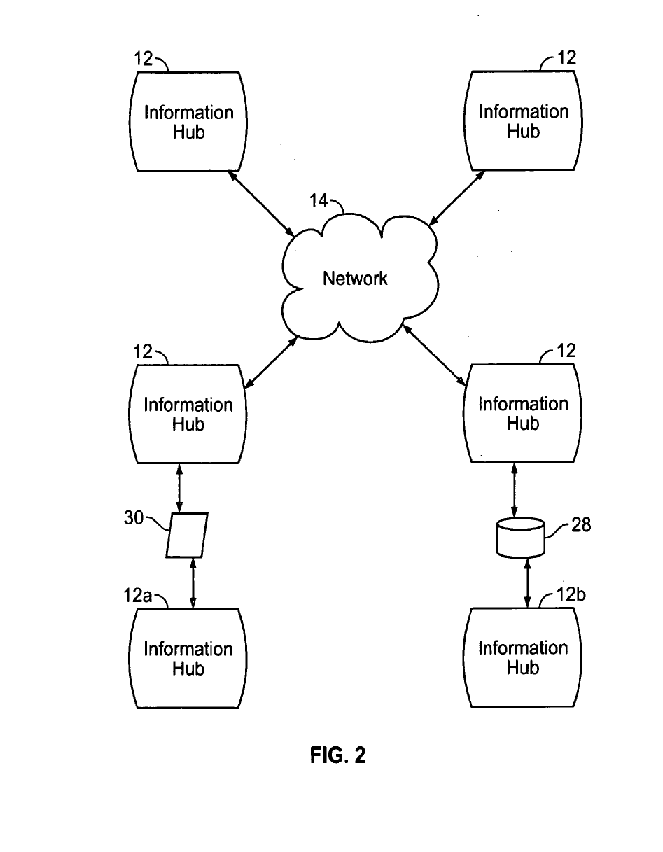

FIG. 1 shows the arrangement of a data transfer apparatus 10 according to one embodiment of the present invention. The data transfer apparatus 10 provides a dynamic architecture for transferring and processing data of any protocol simultaneously across a network 14 to multiple destination nodes (e.g., external hubs 12 of FIG. 2). The data transfer apparatus 10 includes an accessible library creation application (discussed further below) for generating encoding and decoding modules for information to be transferred via the data transfer apparatus such that data of any protocol can be processed within a network via interprocess communication (IPC) or transferred over the network 14 using the Internet Protocol.

As shown in FIGS. 1 and 2, the data transfer apparatus 10 comprises an information hub 12 configured to transfer data over a network 14 via the Internet Protocol or within a system utilizing IPC. The network 14 can be a wired or wireless network. The data transfer apparatus 10 is configured to transfer data between a plurality of external nodes (each node comprising a information hub 12), such as multiple external hubs 12 coupled to the wired Each of the information hubs 12 comprise a computer or other information processing device having computer processing unit (CPU) configured to control the operation thereof. The CPU executes an operating system for the respective computer or device. The information hubs 12 and can include any type of information processing devices such as a personal computer, network computer, lap top computer, notebook, tablet computer, ipad, pda, smart phone, etc.

As further shown in FIG. 1, each of the information hubs 12 include a hub database 2 coupled thereto. The hub database 2 provides a repository for storing libraries and information for carrying out the transfer of data to/from the associated one of the main information hub 12. The hub database 2 also contains libraries and information for processing data via the associated information hub 12 or other devices which may be associated or coupled to the information hub. The hub database 2 resides on a storage medium such as a magnetic disc or computer memory.

The data transfer apparatus 10 of FIG. 1, is further configured to transfer information to/from one or more local applications 26, storage devices 28 and memory 30 coupled to the information hub 12. The storage devices can be any type of solid state, magnetic, optical or other means for storing data. Although the information hub 12 show in the FIG. 1 embodiment includes connections to the local application 26, hub database 2, memory 30 and data storage device or disk 28, these are shown as an example of one configuration of the information hub 12. Accordingly, one skilled in the art will recognize that many different configurations of the information hub 12 and the associated devices are possible including, e.g. wherein one or more of the hub database 2, data storage device 28 or various applications are located remote relative to the information hub 12 or shared by multiple information hubs 12.

Referring to FIG. 2, the data transfer apparatus 10 generates and implements specialized encode/decode modules 7d, 7e, respectively, which may reside on the hub database 2. FIG. 2 is a flowchart showing a process 40 of one embodiment of an encode/decode library generation module 41 for generating the encode/decode modules 7d. 7e for enabling the processing and transferring documents of a certain protocol via the data transfer apparatus 10. In the FIG. 2 embodiment, the process 40 illustrates the creation of the encode and decode modules 7d, 7e respectively, for encoding/decoding a document 7, written in W3C XML schema, as well as any other documents written in W3C XML Schema. The document 7 and the W3C XML Schema is utilized for illustration only as one skilled in the art will recognize the data transfer apparatus 10 is particularly designed for reliable and efficient transfer and processing of information of any format and/or protocol.

Still referring to FIG. 2, the encode/decode module generation process 40 starts a block 42. At step 44, the information of document 7 is read and the schema definition thereof is identified. As mentioned above, in the illustrated embodiment, the document 7 is written in the W3C XML Schema language. At step 46, the information of document 7 is translated to Abstract Syntax Notation One (ASN.1) and an ASN.1 module 7a is generated at step 48 containing the translated XML elements of the document 7. Each of the XML elements of the document 7 is translated to a type of the ASN.1 module 7a. Thus, the ASN.1 module 7a includes an ASN.1 type corresponding to each of the XML elements of the document 7.

The process 40 continues at step 50 wherein a globally unique identifier (ID) is generated for use in a target namespace of the XML schema and the ASN.1 module 7a. In the FIG. 2 embodiment, the unique ID is an ASN.1 type OBJECT IDENTIFIER and corresponds to the ASN.1 format therefor. Thereafter, a Schema ID database 8 is updated to store the new ID and the target namespace for the document 7. Thus, the unique ID for the W3C XML Schema is stored in the Schema ID database and associated therewith. Still at step 50, the ASN.1 module 7a is revised to include the generated OBJECT IDENTIFIER as the ASN.1 module's first type.

At step 52, each of an encode module 7b and a decode module 7c are generated in the target language by compiling the ASN.1 module 7a utilizing an ASN.1 compiler. Although the FIG. 2 embodiment uses ASN.1, other data representation or notation systems can also be used, and are known to one skilled in the art and within the scope of the disclosed subject matter.

At step 54, each of the encode module 7b and decode module 7c is compiled into binary modules 7d, 7e respectively. The binary modules 7d, 7e having a format corresponding to the target architecture. Possible target architectures may include Intel 64, Intel 1A32, Apple A5, or A5x, etc.

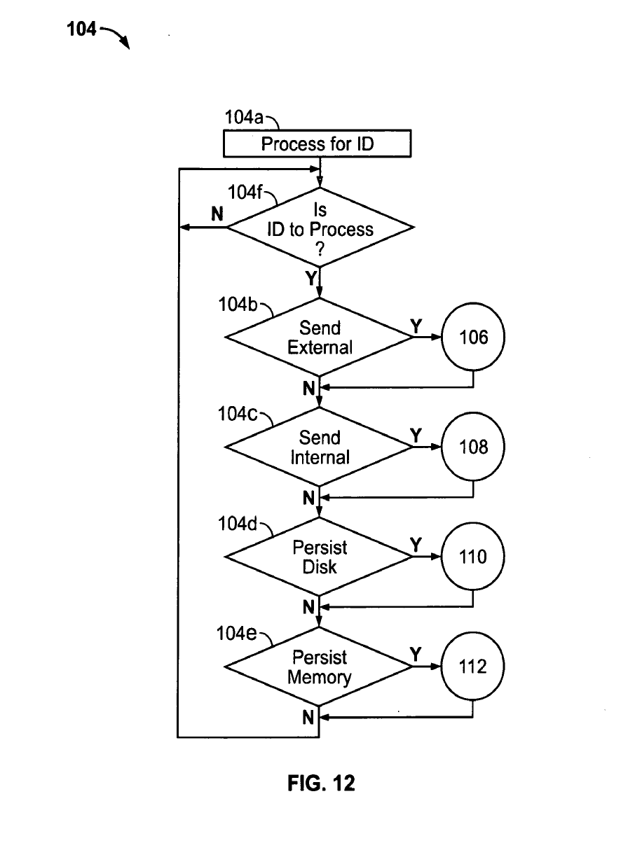

The process 40 continues at step 56 wherein the binary encode/decode modules 7d,7e are bundled to form a library 57 for use at one or more information hubs 12 of FIG. 12. Note, in alternate embodiments of the information hub 12, only one of the encode/decode modules 7d, 7e may be available to the information hub 12 as the hub may be configured to only decode and process, transfer or persist decoded information. Accordingly, in this example, the encode/decode modules 7d, 7e may not be bundled in a library 57, rather deployed individually to a destination information hub 12.

The library 57 and/or each of the encode binary module 7d and decode binary module 7e is indexed with the ASN.1 Object Identifier for the corresponding schema. Once the library 57 comprising the encode binary module 7d and the decode binary module 7e is generated, the library is transferred to, and/or stored on the hub database 2 of one or more information hubs 12 and can be used thereby for encoding and/or decoding any information or documents conforming to the W3C XML Schema. Thereafter, the process 40 ends at block 58.

As set forth above, the data transfer apparatus 10 implements specialized encoding and decoding modules generated specifically for the information designated for transfer via the data transfer apparatus. The process 40, discussed above, generates an encode/decode library 57 including an encoding module 7d and a decoding module 7e corresponding to the document 7 to be transferred to one or more destination nodes (information hubs 12). Accordingly, regardless of the defined schema of the document 7, the process 40 provides specialized encoding and decoding modules 7d, 7e for bundling in an encode/decode library 57 and transfer to a destination node. As discussed further hereinafter, the data transfer apparatus 10 comprises a library deployment application 65, in part, for deploying the library module 57 to any information hubs 12 which may request or require the same.

Thus, the process 40 provides dynamic generation of encode/decode modules for documents of any protocol for processing, transferring, persisting, etc. of the documents by one or more of the information hubs 12. The encode/decode library generation module 41 may reside on the hub database 2 however, one skilled in the art will understand that this is not required as the encode/decode library generation module 41 could reside on any information hub 12 or at a remote location coupled to the network 14 for generating encode/decode modules such as 7d, 7e for use with documents of a different protocol. Utilizing the encode/decode library generation module 41 allows dynamic scalability of the information hub(s) 12 to process and transfer information of any protocol and without the need for a shutdown of the data transfer apparatus 10, software development, or any reconfiguration of any modules or interfaces thereof.

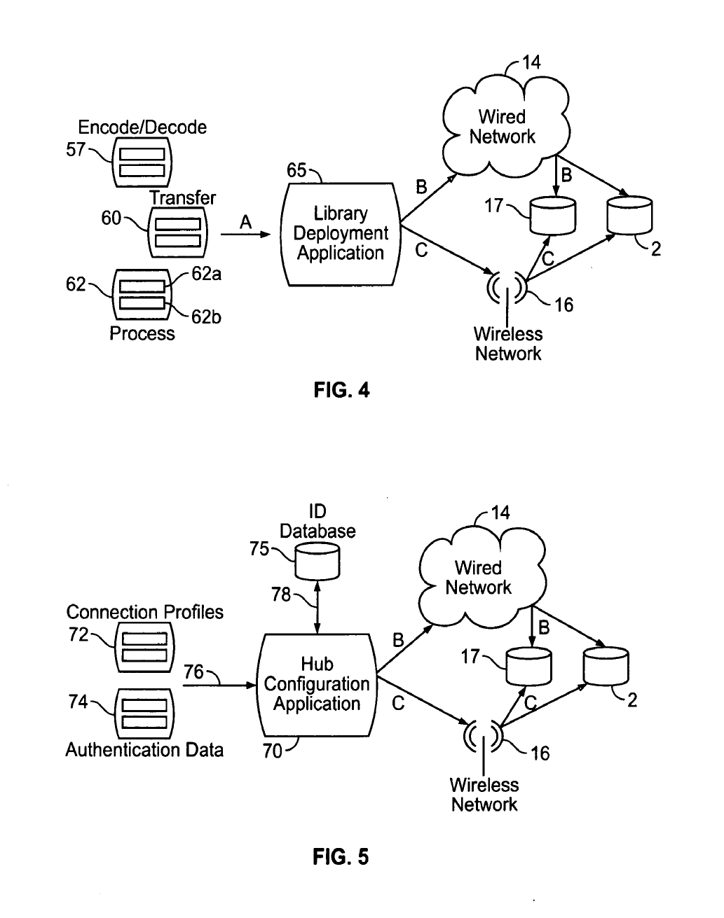

Referring to FIG. 4. the hub database 2 further comprises a transfer library 60 including a suite of modules for use by the data transfer apparatus 10 in carrying out a transfer process (FIG. 1, A-F) including coordinating, authenticating, synchronizing, providing security, and transferring information between one or more of the information hubs 12, local application(s) 26, and storage devices/memory 28, 30. The transfer library 60 includes various applications for carrying out the transfer process (A-F) via known technologies including inter alia, Interprocess Communication, open SSL, LDAP, TCP/IP and Keberos which are known and used in the industry and are therefore not described further herein.

The hub database 2 further comprises a process library 62 including a library of modules 62a, 62b for various processing of schema and other information prior to or following the transfer thereof via the data transfer apparatus 10. The process modules 62a, 62b, etc., may include modules for forwarding information, persisting information and other processing of data or information which may be transferred to/from, or stored in the information hub 12, and/or one or more local application 26, or the storage device/memory 28, 30 associated therewith or coupled thereto.

The data transfer apparatus 10 is dynamically configured and updated by adding or removing modules from one or more of or including additional, encoding/decoding library 57, transfer library 60 and the process library 62. As such, the data transfer apparatus 10 is capable of transferring and/or processing information or data defined in any schema or protocol over the network 14 or processing using any of the information hub(s) 12. Further, the data transfer apparatus 10 is configured to limit the access and/or processing capability of the information hubs (12) by removing and/or restricting access to one or more of the encoding/decoding libraries 57, the process library 62 or the transfer library 60.

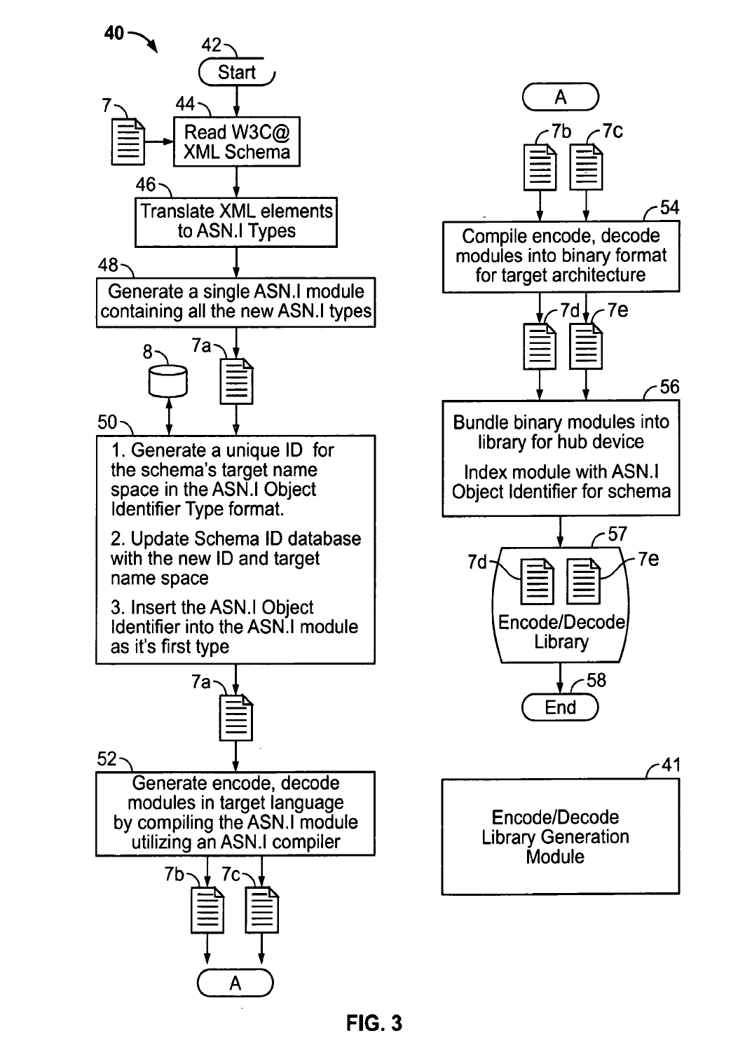

Still referring to FIG. 3, the data transfer apparatus 10 further comprises a library deployment application 65 configured to transfer one or more of the encode/decode library 57, the transfer library 60, and the process library 62 to a one or more information hubs 12 or other destinations coupled to the network 14. As shown in FIG. 3, at step 67 the library deployment application 65 copies one or more of the encode/decode library 57, the transfer library 60, and the process library 62 from the hub database 2 and transfers the same via the network 14 to a destination information hub 12. FIG. 3 further shows a hub database 2 and staging area 17 coupled to and accessible via an associated information hub 12. In one embodiment, the staging area 17 includes an LDAP server that functions as a repository for configurations, libraries, authentication data, etc. for use by the associated information hub 12 in carrying out its processing. One skilled in the art will understand that each of the information hubs 12 coupled to a network 14 may not require access to or the functionality of the library deployment application 65. Accordingly, in accordance with an embodiment of the invention, one or more information hub(s) 12 may not include a library deployment application 65.

As shown in FIG. 5, the data transfer apparatus 10 includes a hub configuration application 70 for configuring external information hubs 12 for corresponding with other of the information hubs 12, as well as local applications 26, storage devices 28 or computer memory 30. The hub configuration application 70 functions to access the hub database 2 to collect connection profiles 72 including configuration data and authentication data 74 for deployment to an external information hub 12 at step 76. At step 78 the hub configuration application 70 reads the current hub IDs from an ID database 75. Next, the hub configuration application 70 generates a new ID code for the information hub being configured and updates the ID database 75 with the new ID code. Still referring to FIG. 5, steps B and C show the hub configuration application transferring the configuration and authentication data 74 and the new ID code via the network 14, 16 to the destination hub (e.g., 12, not shown in FIG. 3). FIG. 5 further shows a hub database 2 and staging area 17 coupled and accessible to the newly configured external information hub 12. The hub configuration application 70 creates a configuration for use in an initialization phase wherein connection and configuration information is retrieved by an external information hub (e.g., 12 for configuring the hub for communication with the data transfer apparatus 10 and for processing and execution of data and information received therefrom.

One skilled in the art will appreciate that the each of the information hubs 12 coupled to a network 14 may not require access to or the functionality of the hub configuration application 70. Accordingly, in accordance with an embodiment of the invention, one or more information hub(s) 12 may not include a hub configuration application 70.

In another embodiment, not shown, one or more of the information hubs 12 may be designated a main information hub 12 and configured to house or have access to certain of the modules such as of the data transfer system 10 such as the encode/decode library generation module 41, library deployment application 65 and the hub configuration application 70. Alternatively, in another embodiment of the data transfer application 10, these ancillary applications may reside at a remote location connectible to the network 1 that is separate and apart from the information hubs 12.

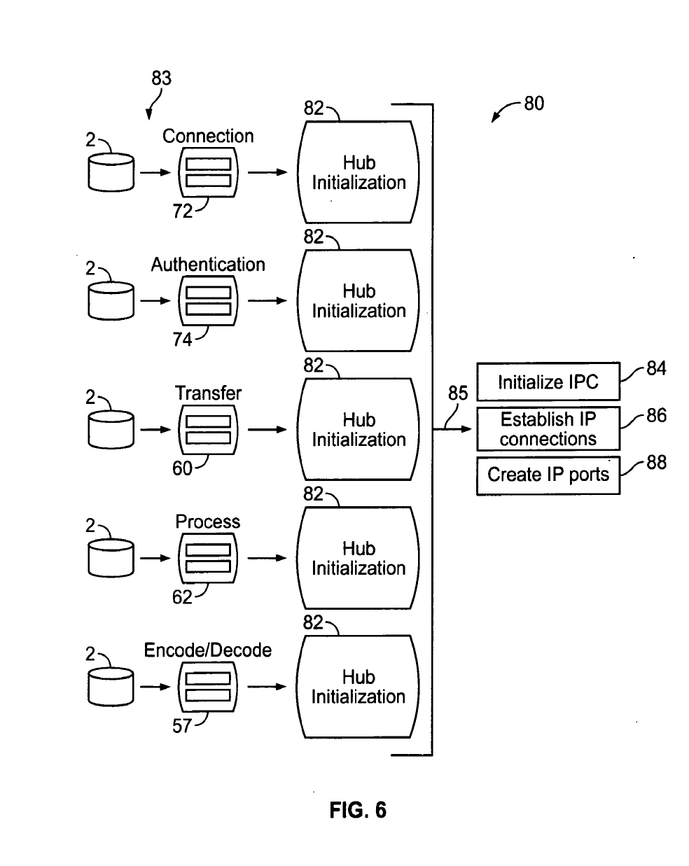

Referring to FIGS. 5-7, the information hub(s) 12 each comprise execution phases including an initialization process 80, main process 90 and termination process 116. The initialization process 80 (FIG. 6), carried out by a hub initialization module 82 retrieves at step 83 from the hub database 2, each of the connection profiles 72, authentication data 74, process library 62 and encode/decode library 57 for an information hub 12 and configures the information hub to communicate with the other information hubs 12 via the network 14, 16. At step 85, the initialization process 80 for the subject information hub 12 continues to initialize all communication connections the information hub will support. At step 84, the process initializes IPC communications for the information hub for communications with any local applications 26. At step 86, Internet Protocol connections are established with external information hubs 12 in the network 14. At step 88, the initialization process 80 creates Internet Protocol ports for allowing external information hubs 12 to establish IP connections for communicating with the information hub 12 being configured. Accordingly, the initialization process 80 retrieves the configuration and definition information for an information hub 12 and sets up the information hub for carrying out the main process 90.

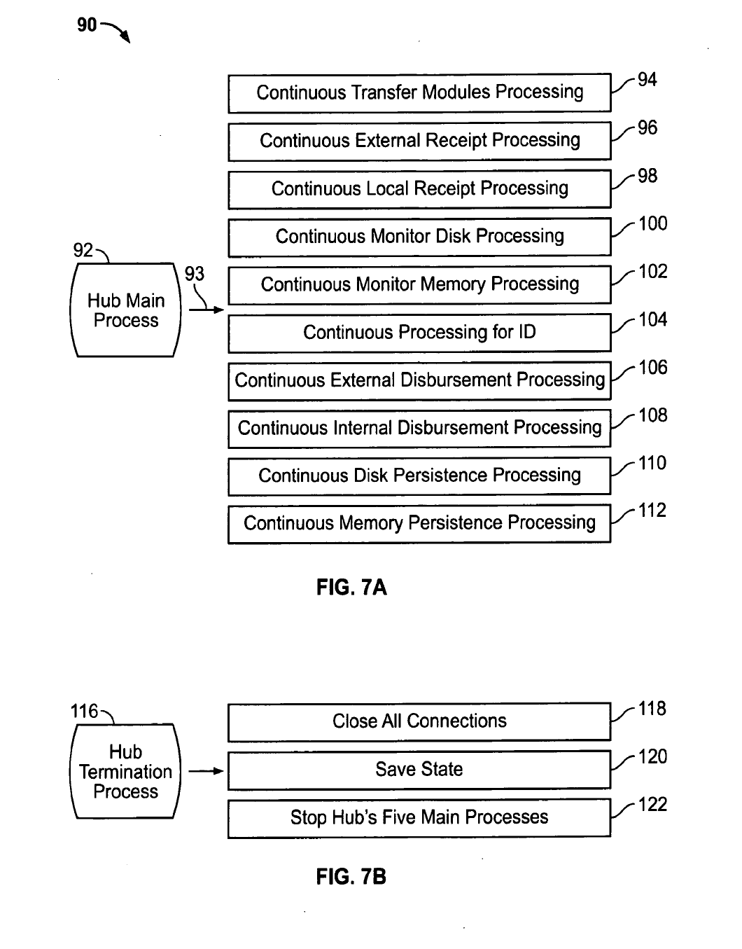

FIG. 7a shows a flowchart of the main process 90 which is carried out by a main process application 92 of the information hub 12. The main process 90 includes at step 93 continuous parallel execution of an information hub's main processes including processing transfer modules, step 94 (See, transfer library 60), external receipt processing, step 96, local receipt processing, step 98, external disbursement processing, step 106, internal disbursement processing, step 108 and persistence processing, steps 110, 112. Step 93 also includes additional processing steps discussed herein following.

The transfer module processing, step 94 continuously monitors and processes all external connections of the information hub 12, including authentication and network session processing for the information hub(s), data/information synchronization, status checking, etc. The transfer module processing 94 includes all connections established by the information hub 12 to external information hubs 12 and all connections established by an external information hub 12 to the subject information hub 12.

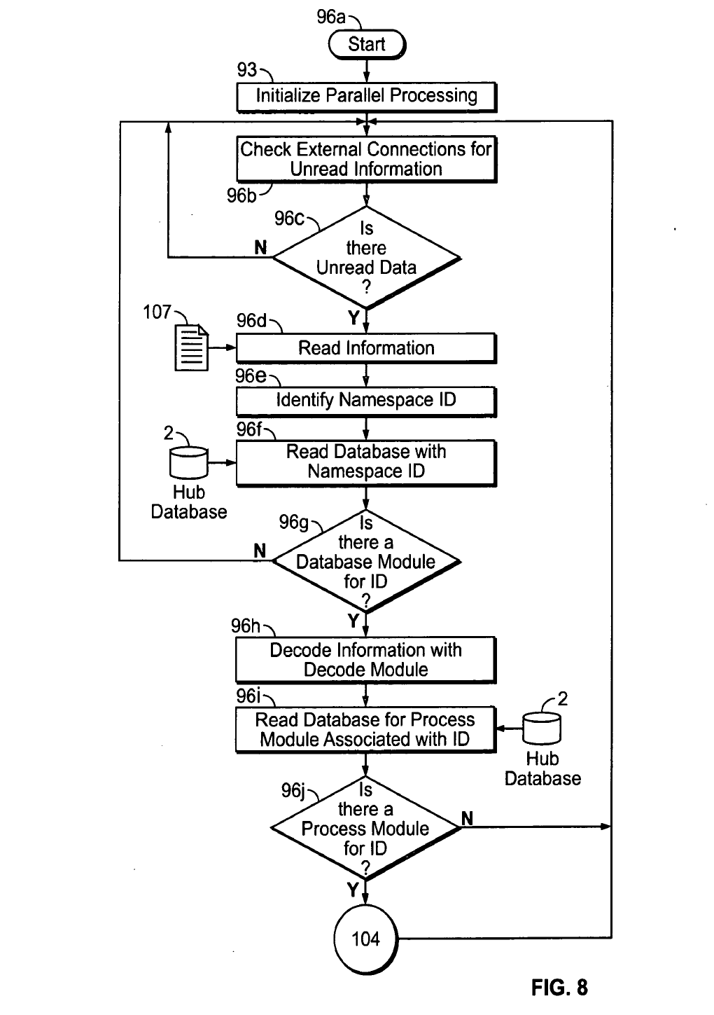

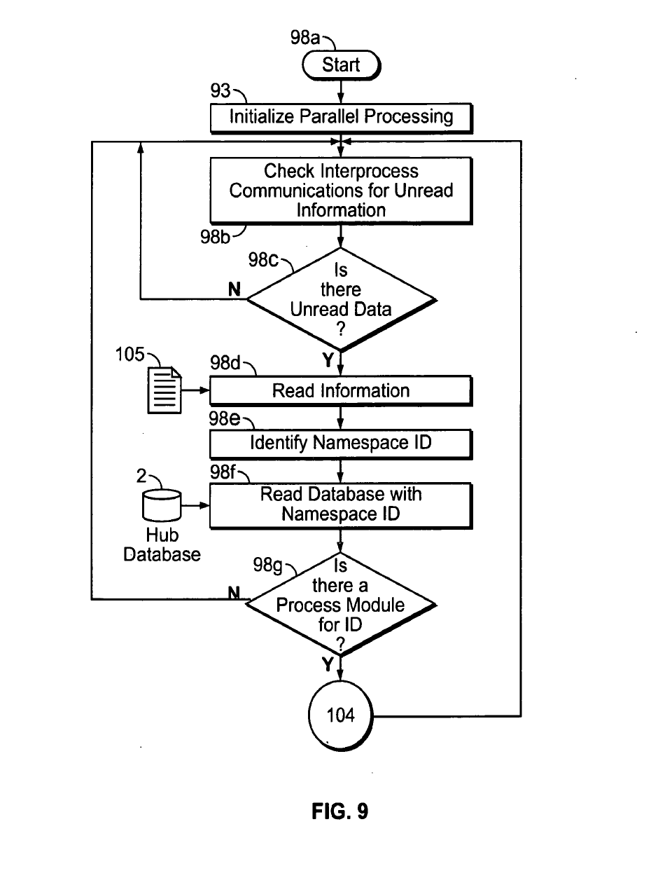

The main process 90 provides continuous external receipt processing at step 96, including in parallel continuous monitoring and processing of data and/or information received from external information hubs 12. FIG. 8 is a flowchart of one embodiment of an external receipt processing application of the data transfer apparatus 10. The external receipt processing step 96 starts at 96a, and proceeds to initialize parallel processing at 93 (See FIG. 6). The parallel processing 93 including the parallel and continuous execution of the steps 94-112 of the main process 90. At step 96b, the external connections of the information hub 12 are checked for unread information. At decision block 96c a determination is made whether or not unread information/data has been received. If no, the process loops back to step 96b to continue checking each of the information hub's 12 external connections. If unread information/data (e.g., encoded document 107) is identified at block 96c, the process continues at block 96d to read the information and obtain the unique ID contained within the received information's 107 target namespace at block 96e. At block 96f, the process accesses the hub database 2 to a decode module (e.g., decode module 7e of FIG. 2) for the document 107. At decision block 96g, if no decode module has been received, the process returns to step 96b to check for unread data. (Thus, if the information hub 12 does not have access to a decode module corresponding to the encoded document, the process 96 cannot decode the document 107 for processing via the information hub). Alternatively, if a decode module has been received, at step 96g, the external receipt process 96 continues to decode the information using the decode modules at step 96h. Thereafter, at block 96i, the hub database is accessed to determine if a processing module is associated with the unique ID of the document 107. At block 96j, a determination is made as to whether or not the received information/data includes an associated processing module. If yes, the process branches to step 104 (See FIG. 12) to execute the process module with the decoded information/data 107 received. Typically the process executes any processing modules in accordance with the decoded information including network level session modules and application level session modules. Once any such process module is executed, the process returns again to step 96b to check the external connections of the hub for unread information in a continuous loop. If the received information/data does not include a processing module, the process 96 returns directly to the step 96b. Thus, the external receipt processing 96 continuously monitors, receives and processes the encoded data and information received from one or more information hubs 12 via the networks 14.

The main process 90 further comprises continuous local receipt processing, step 98, shown in FIG. 7a. The process starts at 98a and continues at step 93 to execute continuous parallel processing of the main process as described above. The local receipt process continues at step 98b wherein the internal connections of the information hub 12 are checked for unread information. A decision block at 98c determines whether or not unread information/data (document 105) has been received. If no, the process loops back to step 98b to continue checking each of the information hub's 12 internal connections. If unread information/data (document 105) is identified at block 98c, the process continues at block 98d to read the information and determine the schema or namespace thereof (block 98e). At block 98f, the hub database 2 is accessed to identify any processing module(s) associated with the unique ID corresponding to the document 105. At block 98g, a determination is made as to whether or not the ID for document 105 includes an associated processing module. If yes, the process branches to step 104 (See FIG. 12) to execute the process module with the information received (document 105). The process executes any processing modules in accordance with the information ID including network level session modules and application level session modules. Once any such process module is executed, the process returns again to step 98b to check the internal connections of the information hub 12 for unread information in a continuous loop. If the received information/data does not include a processing module, the process 98 returns to the step 98b. Thus, the internal receipt process 98 continuously monitors, receives and processes data and information received from the information hub's 12 local application(s) 26.

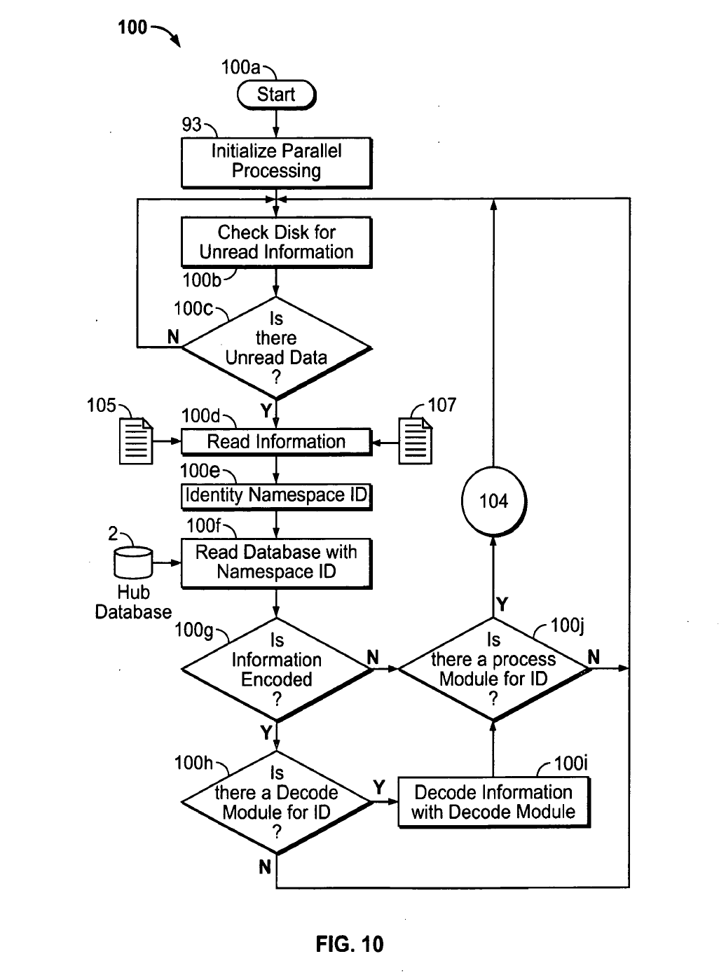

Referring to FIGS. 7a, 10 the main process 90 further includes at step 100 continuous monitor disk processing. As shown in FIG. 10, the disk monitor disk process starts at block 100a and includes initializing continuous parallel processing of the main process 90, shown at step 93. The monitor disk process continues at step 100b wherein the information hub's disk storage device(s) 28 are checked for unread information via, e.g., disk update. A decision block at 100c determines whether or not unread information/data has been received. If no, the process loops back to step 100b to continue checking each of the information hub's disk storage devices. If unread information/data is identified at block 100c, the process continues at blocks 100d and 100e to read the information and extract the namespace and/or unique ID contained within the received information (e.g., document 105 or encoded document 107). At block 100f the hub database is accessed to identify any process modules associated with the namespace ID of the received information. At block 100g, a determination is made as to whether or not the received information (e.g., document 105 or encoded document 107) is encoded. If no, the process continues at decision block 100j wherein a determination is made as to whether or not a process module is associated with the ID for the received information. If no, the process loops to block 100b and checks for unread information. Alternatively, if at decision block 100j, there is a process module associated with the ID for the received information, the process branches to step 104 of FIG. 12 to carry out any identified process.

Returning to block 100g, if the received information is encoded (e.g., encoded document 107), the process continues at block 100g wherein a determination is made as to whether or not a decode module is available for the unique ID of the received information/data. If yes, the process continues at step 100i to execute the decode module resulting in a decoded version of the information/data received. Thereafter, at decision block 100j a determination is made as to whether or not a process module is associated with the ID for the received information. If no, the process loops to block 100b and checks for additional unread information. Alternatively, if at decision block 100j, a process module associated with the ID is available, the process branches to step 104 of FIG. 12 to carry out any identified process on the decoded information. Once any such process module is executed, the process 100 returns again to step 100b to check the disk storage of the information hub for unread information in a continuous loop.

Thus, the disk monitor process 100 continuously monitors, receives and processes data and information stored on the information hub's 12 disk storage devices.

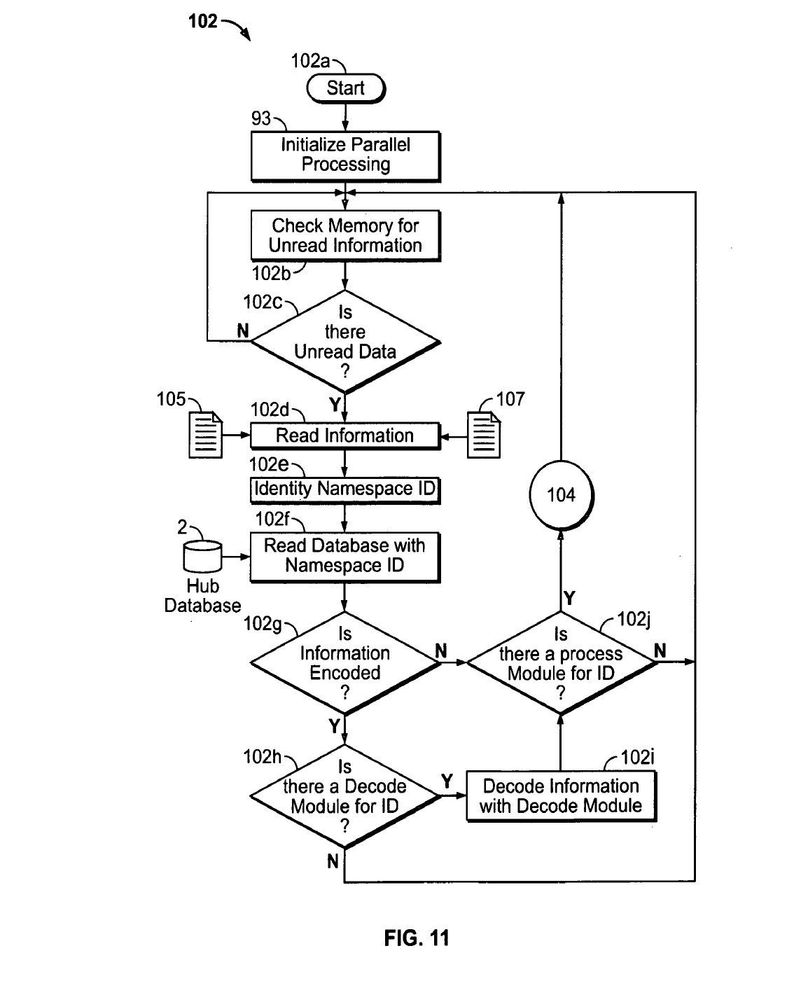

Referring to FIGS. 7a, 11 the main process 90 further includes at step 102 continuous monitor memory processing. As shown in FIG. 11, the monitor memory process starts at block 102a and includes initializing continuous parallel processing of the main process 90, shown at step 93. The monitor memory process continues at step 102b wherein the information hub's memory 30 is checked for unread information. A decision block at 102c determines whether or not unread information/data has been received. If no, the process loops back to step 100b to continue checking each of the information hub's memory locations. If unread information/data is identified at block 102c, the process continues at blocks 102d and 102e to read the information and extract the namespace and/or unique ID contained within the received information (e.g., document 105 or encoded document 107). At block 102f the hub database 2 is accessed to identify any process modules associated with the namespace ID of the received information. At block 102g, a determination is made as to whether or not the received information (documents 105, 107) is encoded. If no, the process continues at decision block 102j wherein a determination is made as to whether or not a process module is associated with the ID for the received information. If no, the process loops to block 102b and checks for unread information. Alternatively, if at decision block 102j, there is a process module associated with the ID for the received information, the process branches to step 104 of FIG. 12 to carry out any identified process.

Returning to block 102g, if the received information is encoded (e.g., document 107), the process continues at block 102h wherein a determination is made as to whether or not a decode module is available for the unique ID of the received information/data. If yes, the process continues at step 102i to execute the decode module resulting in a decoded version of the information/data received. Thereafter, at decision block 102j a determination is made as to whether or not a process module is associated with the ID for the received information. If no, the process loops to block 102b and checks for additional unread information. Alternatively, if at decision block 102j, a process module associated with the ID is available, the process branches to step 104 of FIG. 12 to carry out any identified process on the decoded information. Once any such process module is executed, the process 102 returns again to step 102b to check the memory of the information hub for unread information in a continuous loop.

Thus, the monitor memory process 102 continuously monitors, receives and processes data and information stored on the information hub's 12 memory.

Referring to FIGS. 7a and 12, the main process 90 further includes at step 104 continuous ID processing for identifying and controlling the destination of information transmitted from the information hub 12. As shown in FIG. 12, the ID process module starts at block 104a and includes continuous monitoring for destination ID's. The ID process continues at decision block 104f wherein a determination is made whether or not an ID to process has been identified. If no ID to process has been identified at block 104f, the process loops again to block 104f in a continuous manner to recheck for an ID to process. Otherwise, if an ID has been identified at block 104f, the process continues at block 104b wherein a determination is made whether or not an ID for an external information hub 12 has been identified. If yes, the process branches to process 106 to forward information to the external information hub 12 identified. Once the process 106 is initiated, the process 104 continues at step 104c as set forth following. If no external information hub 12 ID is identified (at block 104b), the ID process continues at decision block 104c wherein a determination is made whether or not an internal destination ID has been identified. If yes, the process branches to process 108 to forward information to the internal destination identified (e.g., 26, etc.). Once the process 108 is initiated, the process 104 continues at step 104d. If no internal ID is identified at block 104c, the ID process continues at decision block 104d wherein a determination is made whether or not information to be stored on a storage device 28 has been received. If yes, the process branches to process 110, for continuous disk persistence processing for storing the information on a storage device. Once the process 110 is initiated, the process 104 continues at step 104e as set forth following. If no storage device is identified at block 104d, the ID process continues at decision block 104e wherein a determination is made whether or not information to be stored in the information hub's 12 memory 30 has been received. If yes, the process branches to process 112, for continuous memory persistence processing for storing the information in the information hub's 12 memory 30. Once the process 112 is initiated, the process 104 returns to step 104f in a continuous manner. If at block 104e, an ID for a memory location is not identified, the process 104 returns to block 104f to again check for an ID to process in a continuous manner.

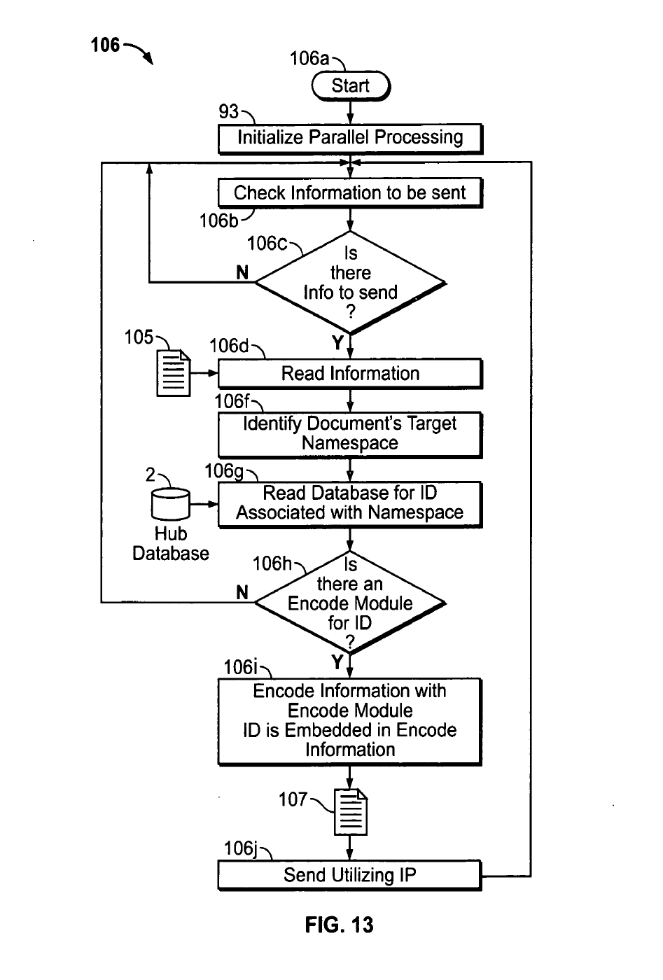

FIG. 13 shows the external disbursement process step 106. The process starts at 106a and continues at step 93 to execute continuous parallel processing of the main process 90 as described above. The external disbursement process 106 continues at step 106b wherein a check is made for information to be sent to external destinations (external information hubs 12). A decision block at 106c determines whether or not information/data to be sent externally has been identified. If no, the process loops back to step 106b. If information/data to be sent to external destinations is identified at block 106c, the process continues at block 106d to read the information (document 105). At block 106f, the document's target namespace is retrieved and/or the schema thereof identified. At block 106g, the hub database 2 is queried to identify the unique ID corresponding to the document 105 based on the target namespace or schema thereof. At block 106h, a determination is made as to whether or not an encode module for the information/data to be sent has been received or is available. If yes, the process continues at step 106i to execute the encoding module and send the encoded information/data 107 to the external hub via the IP protocol at step 106j. Thereafter, the process returns to step 106b to check for information to be sent to an external hub in a continuous process. If it is determined that an encoding module is not available for the received information at step 106h, the process returns to the step 106b and checks for additional information/data to be sent to external hubs. If no encoding module is available, the information hub 12 passes over the information and continues at step 106b. Thus, the external disbursement process 106 continuously monitors, receives and processes data and information from the information hub 12 to be sent to external information hubs 12.

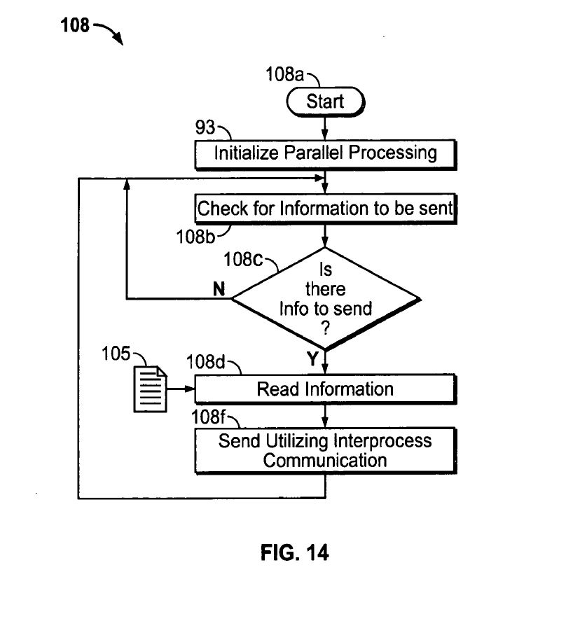

FIG. 14 shows a flowchart of one embodiment of the internal disbursement process step 108. The process starts at 108a and continues at step 93 to execute continuous parallel processing of the main process 90 as described above. The internal disbursement process 108 continues at step 108b wherein a check is made for information to be sent to the internal destinations. A decision block at 108c determines whether or not information/data to be sent internally has been identified. If no, the process loops back to step 108b. If information/data to be sent to internal destinations is identified at block 108c, the process continues at block 108d to read the information (e.g. document 105) and at block 108f to send the information/data to the appropriate internal destination hub via IPC. Thereafter, the process returns to step 108b to check for information to be sent to an internal location in a continuous process.

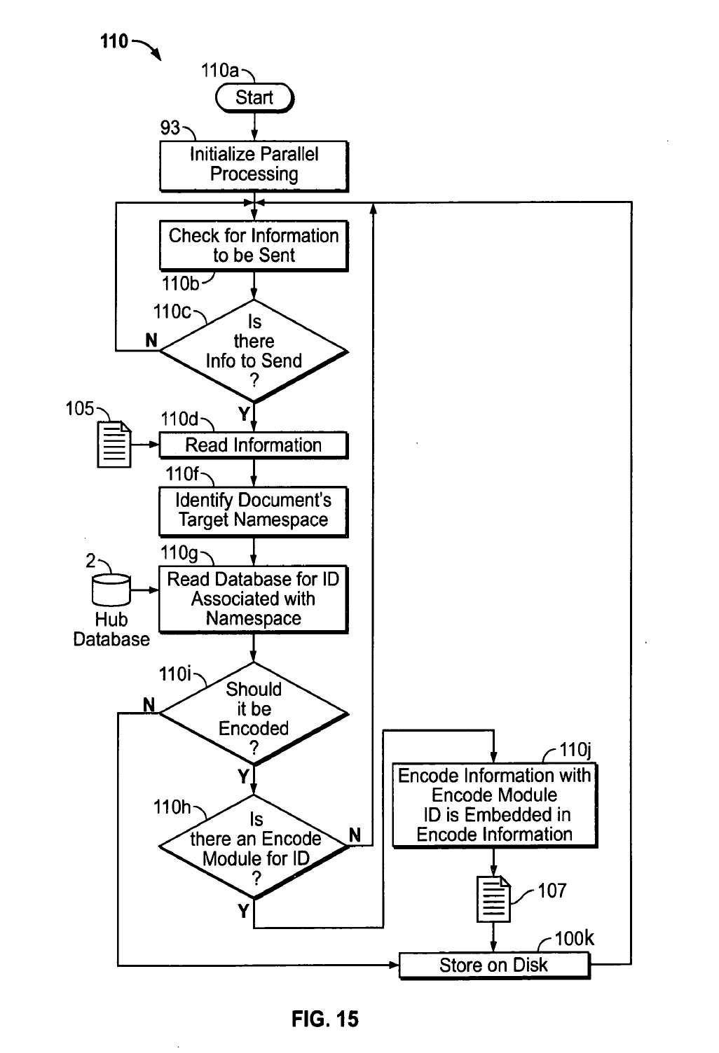

FIG. 15 shows a flowchart of one embodiment of the continuous disk persistence process step 110. The process starts at 110a and continues at step 93 to execute continuous parallel processing of the main process 90 as described above. The disk persistence process 110 continues at step 110b wherein a check is made for information to be stored on a storage device 28. A decision block at 110c determines whether or not information/data to be stored on a storage device has been identified. If no, the process loops back to step 110b. If information/data to be stored on a storage device is identified at block 110c, the process continues at block 110d to read the information/data (document 105) identified. At step 110f, the document's target namespace is identified. At step 110g, the hub database 2 is accessed to determine the unique ID associated with the document's schema (determined from the document and/or the target namespace thereof). The process continues at block 110i to determine whether or not the information (document 105) should be encoded. If yes, at step 110h, a determination is made as to whether or not an encode module 7d is available for the ID. If at block 110i, the determination is no, the decoded or uncoded information 105 is stored on the disk at block 110k and the process returns to block 110b to check for information to be stored on a storage device 28. Returning to step 110h, if it is determined the information hub 12 has an encoding module corresponding to the ID, the document 105 is encoded at step 110j including embedding the unique ID in the encoded information. Thereafter, the encoded information 107 is stored on the disk 110k and the process returns to step 110b.

Returning to step 110h, if there is no encode module for the ID, the process returns to step 110b to check for information to be stored in an internal storage device in a continuous process.

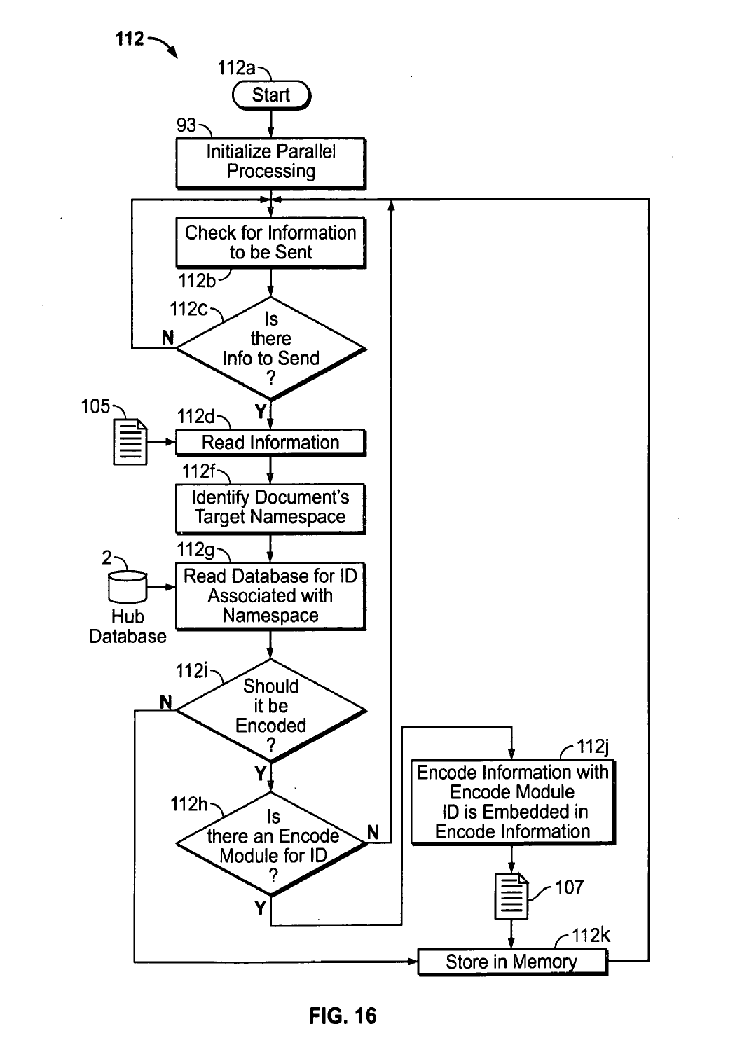

FIG. 16 shows a flowchart of one embodiment of the continuous memory persistence process step 112. The process starts at 112a and continues at step 93 to execute continuous parallel processing of the main process 90 as described above. The memory persistence process 112 continues at step 112b wherein a check is made for information to be stored on the information hub's 12 memory 30. A decision block at 112c determines whether or not information/data to be stored in memory has been identified. If no, the process loops back to step 112b. If information/data to be stored in memory is identified at block 112c, the process continues at block 112d to read the information/data (document 105) identified. At step 112f, the document's target namespace is identified. At step 112g, the hub database 2 is accessed to determine the unique ID associated with the document's schema (determined from the document and/or the target namespace thereof). The process continues at block 112i to determine whether or not the information (document 105) should be encoded. If yes, at step 112h, a determination is made as to whether or not an encode module 7d is available for the ID. If at block 112i, the determination is no, the decoded or uncoded information 105 is stored in memory at block 112k and the process returns to block 112b to check for information to be stored in memory. Returning to step 112h, if it is determined the information hub 12 has an encoding module corresponding to the ID, the document 105 is encoded at step 112j including embedding the unique ID in the encoded information. Thereafter, the encoded information 107 is stored in memory at 112k and the process returns to step 112b.

Returning to step 112h, if there is no encode module for the ID, the process returns to step 112b to check for information to be stored in memory in a continuous process.

Referring to FIG. 7b, the hub termination process 114 in one embodiment is carried out by a hub termination process application 116 that executes an organized shut down of the information hub's 12 processes. The hub termination process includes at step 118 a close all connections function wherein all of the information hub's 12 external and internal connections are closed in an orderly fashion. At step 120, the process continues to save the current state of the information hub's 12 databases, memory and registers. The hub termination process continues at step 122 wherein the main processes of the information hub 12 are stopped and the termination process completed.

In another embodiment, the invention includes a method of transferring and processing information between multiple nodes of a distributed system as carried out via one or more of the information hubs 12 as configured, initialized and connected as described above.

According to one embodiment, at each information hub 12 the method includes continuous processing of the main process 93 as set forth in FIG. 7a and described above. The method including transferring a document of any protocol between nodes (information hubs 12) of a distributed system.

The method including determining a schema of a document to be transferred from a source node to a destination node of a distributed system, encoding the document at the source node using an encoding module corresponding to the schema of the document, the encoding including embedding a unique identifier assigned to the schema in the encoded document, the unique identifier corresponding to the schema of the document and any process associated therewith. The method further comprising transferring the document to at least one destination node of the system; and decoding the document at the destination node using a decoding module corresponding to the schema of the document, the decoding including restoring the document to its original form for processing at the destination node.

The method further including generating each of an encoding and decoding module corresponding to the schema of each protocol of the documents to be transferred between nodes of the system in accordance with the process 40 of FIG. 3. The transferring of documents between the nodes (information hubs 12) including transferring documents of any protocol between nodes of the system simultaneously over a single communication channel using the IP protocol.

In one embodiment, the method of the invention further comprising in one wherein the schema is an XML language and the step of generating an encoding module includes translating each element of the XML schema into a type of an ASN.1 module as set forth in process 40 of FIG. 3.

Another embodiment of the method of the invention includes deploying to a node of the system at least one of an encoding and decoding module corresponding to each protocol of documents to be processed by the node.

In a further embodiment, a non-transitory computer-readable medium comprising instructions that when executed by a processor perform the method steps of the invention as set forth herein above.

Accordingly, in one embodiment, the invention includes a non-transitory computer-readable medium comprising instructions that when executed by a processor perform the method steps of determining a schema of a document to be transferred from a source node to a destination node of a distributed system; encoding the document at the source node using an encoding module corresponding to the schema of the document, the encoding including embedding a unique identifier assigned to the schema in the encoded document, the unique identifier corresponding to the schema of the document and any process associated therewith; transferring the document to at least one destination node of the system; and decoding the document at the destination node using a decoding module corresponding to the schema of the document, the decoding including restoring the document to its original form for processing at the destination node.

Further the computer-readable medium comprising instructions wherein the method includes transferring documents of any protocol between nodes of the system simultaneously over a single communication channel using the IP protocol.

The above embodiments have described the disclosed data transfer apparatus 10, and related system, and method including wherein an XML schema is transferred in ASN.1 format. However, the present invention is not limited to this, and the data transfer process of the present invention can be applied in various communication environments in which data are transferred between devices.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for processing and transferring documents of any protocol between nodes in a distributed system, the apparatus comprising:
a computer processor;
at least one of an encoding module and a decoding module corresponding to a schema of a document, each of the encoding and decoding modules having a unique identifier corresponding to the schema and a process associated with the schema, the encoding module being configured to encode the document including embedding the unique identifier into the document for processing via the apparatus, the decoding module being configured to decode an encoded document of the associated schema including restoring the document to the original form thereof;
a main process module for parallel processing of a plurality of transfer and/or processing modules for processing documents received by the apparatus; and wherein
the apparatus is scalable for transferring and processing documents of any protocol throughout a distributed system.

2. The apparatus according to claim 1, further comprising a database accessible to the computer processor for storing a plurality of pairs of encoding and decoding modules, each pair of encoding and decoding modules corresponding to a particular schema of documents to be processed by the apparatus.

3. The apparatus according to claim 1, further comprising an encode/decode library creation module for generating a pair of encoding and decoding modules for each schema of a plurality of schema for extending the capability of the apparatus for processing documents of each of the plurality of schema.

4. The apparatus according to claim 3, further comprising a library deployment module for transferring the encoding and decoding modules for each schema to a plurality of nodes of a distributed system for processing documents of each schema at each of the nodes.

5. The apparatus according to claim 3, further comprising wherein the schema is an XML language and translated to an ASN.1 module via the encode/decode library creation module, each of the XML elements being translated to a type of the ASN.1 module.

6. The apparatus according to claim 5 further comprising wherein the unique identifier is generated by the library creation module for use in the ASN.1 module as a type OBJECT IDENTIFIER.

7. A distributed system for processing and transferring documents of any protocol between nodes of the system, the system comprising:
a plurality of nodes, each node coupled to a network;
each node having an apparatus comprising:
a computer processor;
at least one of an encoding module and a decoding module corresponding to a schema of a document, each of the encoding and decoding modules having a unique identifier corresponding to the schema and a process associated with the schema, the encoding module being configured to encode the document including embedding the unique identifier into the document for processing via the apparatus, the decoding module being configured to decode an encoded document of the associated schema including restoring the document to the original form thereof;
a main process module for parallel processing of a plurality of transfer and/or processing modules for processing documents received by the apparatus; and
the system is scalable for transferring and processing documents of any protocol between the nodes of the system.

8. The system of claim 7 wherein at least two of the nodes are coupled one to the other via a common memory or storage device for accessing data stored therein by either of the at least two nodes.

9. The system of claim 7, further comprising an encode/decode library creation module for generating a pair of encoding and decoding modules for each schema of a plurality of schema for extending the capability of the apparatus of the system for processing documents of each of the plurality of schema.

10. The system of claim 7 wherein the documents of any protocol are transferred between the nodes of the system simultaneously and via a single channel.

11. The system according to claim 9, further comprising a library deployment module for transferring the encoding and decoding modules for each schema to a plurality of the nodes of the system for processing documents of each schema at each of the plurality of the nodes.

12. The system according to claim 9, further comprising wherein the schema is an XML language and translated to an ASN.1 module via the encode/decode library creation module, each of the XML elements being translated to a type of the ASN.1 module.

13. The system according to claim 7 further comprising wherein the unique identifier is generated by the library creation module for use in the ASN.1 module as a type OBJECT IDENTIFIER.

14. A method of transferring a document of any protocol between nodes of a distributed system, the method comprising:
determining a schema of a document to be transferred from a source node to a destination node of a distributed system;
encoding the document at the source node using an encoding module corresponding to the schema of the document, the encoding including embedding a unique identifier assigned to the schema in the encoded document, the unique identifier corresponding to the schema of the document and any process associated therewith;
transferring the document to at least one destination node of the system; and
decoding the document at the destination node using a decoding module corresponding to the schema of the document, the decoding including restoring the document to its original form for processing at the destination node.

15. The method of claim 14 including generating each of an encoding and decoding module corresponding to the schema of each protocol of the documents to be transferred between nodes of the system.

16. The method of claim 14 wherein the step of transferring includes transferring documents of any protocol between nodes of the system simultaneously over a single communication channel using the IP protocol.

17. The method of claim 15 further comprising wherein the schema is an XML language and the step of generating an encoding module further comprises translating each element of the XML schema into a type of an ASN.1 module.

18. The method of claim 14 further comprising deploying to a node of the system at least one of an encoding and decoding module corresponding to each protocol of documents to be processed by the node.

19. A non-transitory computer-readable medium comprising instructions that when executed by a processor perform a method, the method comprising:
determining a schema of a document to be transferred from a source node to a destination node of a distributed system;
encoding the document at the source node using an encoding module corresponding to the schema of the document, the encoding including embedding a unique identifier assigned to the schema in the encoded document, the unique identifier corresponding to the schema of the document and any process associated therewith;
transferring the document to at least one destination node of the system; and
decoding the document at the destination node using a decoding module corresponding to the schema of the document, the decoding including restoring the document to its original form for processing at the destination node.

20. The computer-readable medium of claim 19 further comprising instructions wherein the method includes transferring documents of any protocol between nodes of the system simultaneously over a single communication channel using the IP protocol.
